(19) United States
(12) Patent Application Publication
(10) Pub. No.: US 2009/0141967 A1
(43) Pub. Date: Jun. 4, 2009

(54) IMAGE PROCESSING APPARATUS AND IMAGE PROCESSING METHOD

(75) Inventor: Hiroshi Hattori, Akishima (JP)

Correspondence Address: GREGORY TUROCY;AMIN, TUROCY & CALVIN, LLP, NATIONAL CITY CENTER, 1900 EAST 9TH STREET, 24TH FLOOR, CLEVELAND, OH, 44114, US

(73) Assignee: KABUSHIKI KAISHA TOSHIBA, Tokyo (JP)

(21) Appl. No.: 12/212,764

(22) Filed: Sep. 18, 2008

(30) Foreign Application Priority Data
Nov. 30, 2007 (JP) 2007-310775

(51) Int. Cl. G06K 9/00

(52) U.S. Cl. 382/154

(57) ABSTRACT

A disparity function setting unit configured to set a plurality of disparity relationships expressing disparities as functions of an image position; a data term calculating unit configured to calculate the similarity of corresponding areas between images specified by the preset disparity functions; a smoothing term calculating unit configured to calculate the consistency between the disparity functions and the pixels located in the vicinity; and a disparity function selecting unit configured to select the disparity function for each point of the image from the plurality of preset disparity functions are provided.

### CROSS REFERENCE TO RELATED APPLICATIONS

This application is based upon and claims the benefit of priority from the prior Japanese Patent Application No.2007-310775, filed on Nov. 30, 2007; the entire contents of which are incorporated herein by reference.

### FIELD OF THE INVENTION

The present invention relates to an image processing apparatus and an image processing. Specifically, the invention relates to an apparatus and method of measuring the distance to an object using an input unit such as a camera based on stereo disparity.

### DESCRIPTION OF THE BACKGROUND

Stereo vision for measuring the distance to an object using two cameras based on trigonometry is an effective image processing technology used in various fields.

The most important and difficult subject in the stereo view is to search corresponding points between stereo images and obtain positional difference between the corresponding points (i.e., “disparity”) for the individual images. There are various methods of calculating the stereo disparity, and these methods are roughly divided into a local method and a global method.

In the local method, (non-) similarity of the local intensity patterns is calculated based on the SAD (Sum of Absolute Difference), SSD (Sum of Squared Difference) or NCC (Normalized cross correlation) in a window, and a point which has the most similar intensity pattern on an epipolar line is selected as a corresponding point. The local method has merits such that the process is simple, and the disparity is basically obtained independently for each point, so that the speeding-up including parallelization of processes is easily achieved. On the contrary, it has a drawback such that the disparity cannot be obtained accurately for a point having no sufficient change in intensity there around.

In contrast, in the global method, an energy function for the disparities of all pixels are defined, and a combination of disparities having the minimum function value is obtained (e.g., see V. Kolmogorov and R. Zabih, “Computing Visual Correspondence with Occlusions using Graph Cuts,” IEEE International Conference on Computer Vision (ICCV), 2001). In this global method, the disparity can be restored even for an area having no pattern since a global disparity is estimated.

Calculation of the stereo disparity may be generalized to a problem of selecting an adequate label fₚ from among prepared disparity candidate labels L and allocating the selected one to each point pεP of an image P in advance.

A label which provides the minimum energy function value of E (f) as shown in the following expression (1) is the disparity to be obtained.

E(f)=E_{data}(f)+Eₛₘₒₒₜₕ(f), (1)

where f=(f₁, f₂, . . . , fₚ, . . . , f_{|p|}) is a label for all pixels of the image P. |P| denotes the number of pixels.

E_{data}(f) in the first term of the expression (1) is referred to as a data term, and represents a degree of disagreement between an estimated label and an observational data (when they agree, the degree of disagreement is normally “0”), and is given by the expression (2).

$${E}_{data} ( f ) = {\sum }_{p ∈ P} {D}_{p} ( {f}_{p} ) , \qquad ( 2 )$$

where Dₚ(fₚ) represents the cost of allocating fₚ as an estimated label (disparity) of a pixel p.

In the local method, in which the label (disparity) estimation is independently performed in each point, f having the minimum first term value is obtained. The second term Eₛₘₒₒₜₕ is referred to as a smoothing term, which denotes the degree of local non-smoothness, and is given by the expression (3).

$${E}_{smooth} ( f ) = {\ddot{\sum }}_{\{ p , q \} ∈ N} {V}_{p , q} ( {f}_{p} , {f}_{q} ) , \qquad ( 3 )$$

where N is a set of adjacent points, and Vₚ,_{q}(fₚ, f_{q}) denotes the cost of allocating fₚ and f_{q} respectively as identification labels of the points p and q.

A model as shown in the expression (4) is a general expression of Vₚ,_{q}(fₚ, f_{q}).

V_{p,q}(fₚ,f_{q})=λ·T(fₚ≠f_{q}), (4)

where T(·) is an operator which returns 1 when the condition provided as an argument is true, and returns 0 in other cases.

When fₚ is not equal to f_{q}, T is “1,” and when fₚ is equal to f_{q}, T is “0.” Therefore, when the disparities of the adjacent pixels are different, a penalty λ of a positive constant is given, and when they are the same, “0” is given. The locally uniform disparity, that is, the surface of an object which has an inclination locally parallel to the surface of the image is not likely to be restored correctly.

For example, when the disparities of a road scene are restored by a stereo camera mounted on a car, the normal vector of the road surface and the optical axis of the camera are substantially orthogonal to each other in general, and therefore an assumption of having a locally uniform disparity is not applied to this, and hence the disparity cannot be estimated correctly.

### SUMMARY OF THE INVENTION

Accordingly, one advantage of an aspect of the present invention is to provide an image processing apparatus and an image processing method which enables a calculation of highly accurate disparity.

To achieve the above advantage, one aspect of the present invention is to provide an image processing apparatus including an input unit configured to input a first image and a second image being input at different position and having a common field of view; a disparity function storing unit configured to store disparity functions for obtaining disparities of a plurality of target points on the first image from coordinates of the individual target points; a first calculating unit configured to obtain the disparity based on the disparity functions from the coordinates of the target points; a second calculating unit configured to obtain corresponding points on the second image corresponding to the target points based on the obtained disparity; a intensity difference calculating unit configured to calculate the intensity differences between the intensity of the target points and the intensity of the corresponding points respectively; an agreement calculating unit configured to calculate the agreement the value of which is reduced with the increasing similarity between the disparity function of the each target point and the disparity function of another target point located around the each target point; and a disparity function selecting unit configured to obtain a combination of the disparity functions with which the minimum sum of the luminance differences and the consistencies for the plurality of target points is obtained while changing the disparity functions of the target points respectively.

### BRIEF DESCRIPTION OF THE DRAWINGS

FIG. 1 is a schematic view illustrating an image processing apparatus according to a preferred embodiment of the invention;

FIG. 2 is a schematic view illustrating a coordinate system used in the image processing apparatus;

FIG. 3 is an explanatory view of disparity functions;

FIG. 4 is an explanatory view of a graph G; and

FIG. 5 is an explanatory view of division of the graph G.

### DETAILED DESCRIPTION OF THE INVENTION

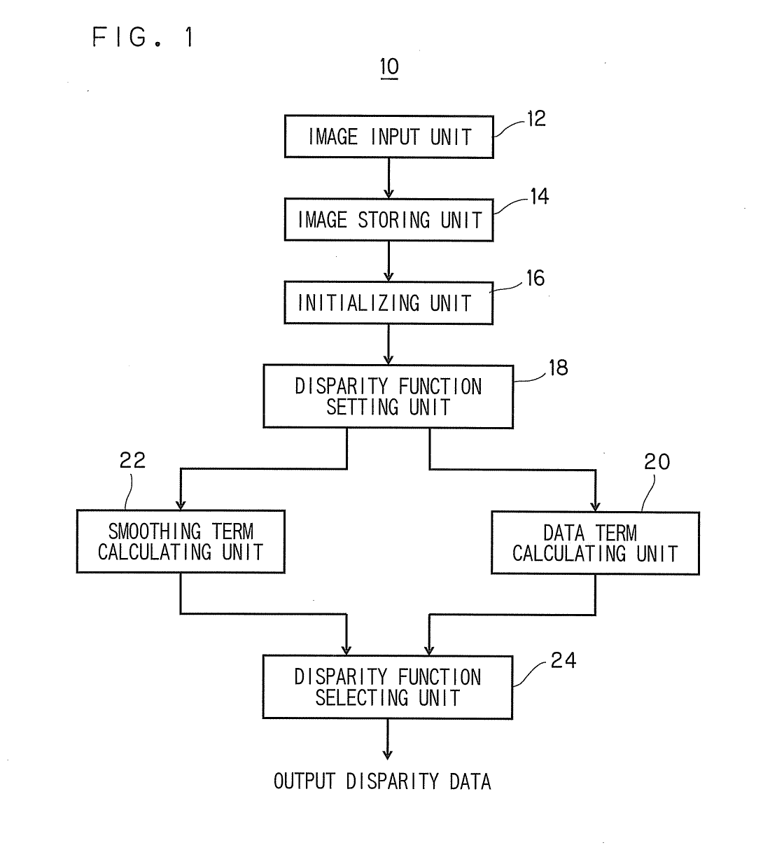

Referring now to FIGS. 1 to 5, an image processing apparatus according to an embodiment of the invention will be described.

A schematic view of an image processing apparatus 10 is shown in FIG. 1. The image processing apparatus 10 includes an image input unit 12, an image storing unit 14, an initializing unit 16, a disparity function setting unit 18, a data term calculating unit 20, a smoothing term calculating unit 22 and a disparity function selecting unit 24. The image processing apparatus 10 outputs disparity functions of a given image as processing results.

The term “disparity function” is an example of the disparity as a function of image position (x, y), and the mode is arbitrary as long as it is the function of the image position. In this embodiment, the image position is expressed by a linear function as shown in the expression (5).

d=αx+βy+γ, (5)

where f=(α, β, γ) of the disparity function is referred to as “disparity affine parameter.” Since the disparity affine parameter and the disparity function have one-to-one correspondence, obtaining the disparity function of the each point is equal to obtaining the disparity affine parameter of the each point.

The disparities of all points in the image are expressed in bulk as “disparity map.” Likewise, the disparity affine parameters are expressed in bulk as “disparity affine parameter map.” When serial numbers 1, 2, . . . , p, . . . , |p| are mapped to the image, the disparity affine parameter map F is given by the expression (6). The value of F is a variable to be obtained.

F=(f₁,f₂, . . . ,fₚ, . . . ,f_{|P|}) (6)

The image input unit 12 inputs a plurality of images from different points of view using a camera.

The multiple-viewpoint image may be input by two or more cameras simultaneously, or may be input by moving one camera when no moving object is included in a scene to be input. The orientation of the camera is arbitrary as long as the fields of view are overlapped with each other.

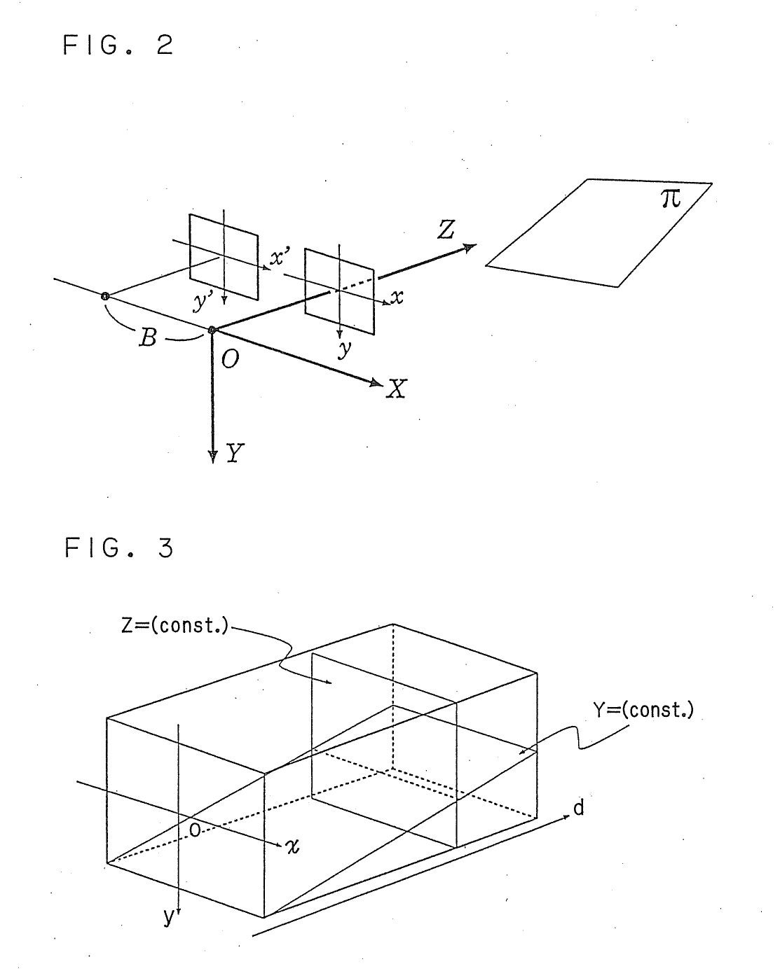

In this embodiment, a circumstance in which two cameras having the same configuration are arranged in lateral parallel to each other to take a stereo image is assumed. The coordinate system shown in FIG. 2 is set to the image processing apparatus 10. The origin is set to be a viewpoint (center of the lens) of the right camera, and a straight line connecting the viewpoints of the left and right cameras is set to be an X-axis, the direction vertically downward is set to be a Y-axis, and the direction of optical axis of the camera is set to be a Z-axis. The distance (the length of the basic line) between the cameras is denoted by B and the position of the left camera is (−B, 0, 0).

Then, as shown in FIG. 2, x and y axes are set in the horizontal and vertical directions for the right image, and x′ and y′ axes are set in the same manner for the left image, and the horizontal direction of these images correspond to the X-axis direction.

In such a case, assuming that corresponding points on the left image with respect to the point (x, y) on the right image are (x′, y′), y is equal to y′. Therefore, only the difference in position in the horizontal direction should be considered. In the description given below, the difference in the horizontal position is referred to as “disparity,” and is expressed as d=x′−x with the right image as a reference image.

The image storing unit 14 stores the stereo images input by the image input unit 12 in an image memory.

The initializing unit 16 initializes the disparity function of each point of the reference image, that is, the disparity affine parameter map F.

The initial value may be a given value, but the disparity map calculated by block matching, for example, may be used as the initial value.

The difference of the corresponding pixels between the stereo images when assuming a given disparity d(dₘᵢₙ<=d<=dₘₐₓ) in a search range is calculated for the each pixel p. The difference between the corresponding pixels is calculated by the expression (7) using the disparity d described above;

Dₚ(d)=|I(p)−I¹(p+d)|^{2,} (7)

where I and I′ are stereo images and I(p) is the luminance value of the point p.

In the description given above, the difference is the square of the difference in luminance value between the corresponding pixels. However, it is also possible to employ the summation of absolute values of the luminance difference of the pixels around the corresponding pixel, the sum of squares of the luminance difference, or the normalized cross correlation. However, since the normalized cross correlation indicates the agreement while other measures indicate the difference (disagreement), it is necessary to carry out a suitable conversion such as the inversion of sign.

The disparity function setting unit 18 supplies an intermediate result of the disparity affine parameter map F supplied from the initializing unit 16 or a disparity function selecting unit 24 descried below and a disparity function fα to the data term calculating unit 20 and the smoothing term calculating unit 22.

By setting a plurality of the disparity functions fα in advance using an advance knowledge relating to the scene to be input and using the same in sequence, the efficiency of the process is improved.

The linear disparity function represents a plane in an actual space. The reason is described now below.

In the coordinate system shown in FIG. 2, the projecting position (x, y) to the reference image of a point (X, Y, Z) in a space and the disparity d are given by the expression (8).

x=X/Z, y=Y/Z d=B/Z, (8)

where the focal distance of the lens is omitted for simplification.

When X, Y and Z are cleared using the expression (8) with an equation of a plane π in the space as Z=pX+qY+r, the equation of the space plane π will be a linear disparity function as shown in expression (9):

d=αx+βy+γ, (9)

where, α=−pγ, β=−qγ, γ=B/r.

The disparity function represents a plane in the actual space, and hence the disparity function setting unit 18 sets the disparity function corresponding to the plane which can exist in the actual space. For example, in the case of the road scene, it is assumed that the object exists above the road surface in many cases, and hence what should be considered is the disparity function of the plane existing above the reference plane (road). FIG. 3 shows an example of two disparity functions of a horizontal plane (Y=constant) and a vertical plane (Z=constant).

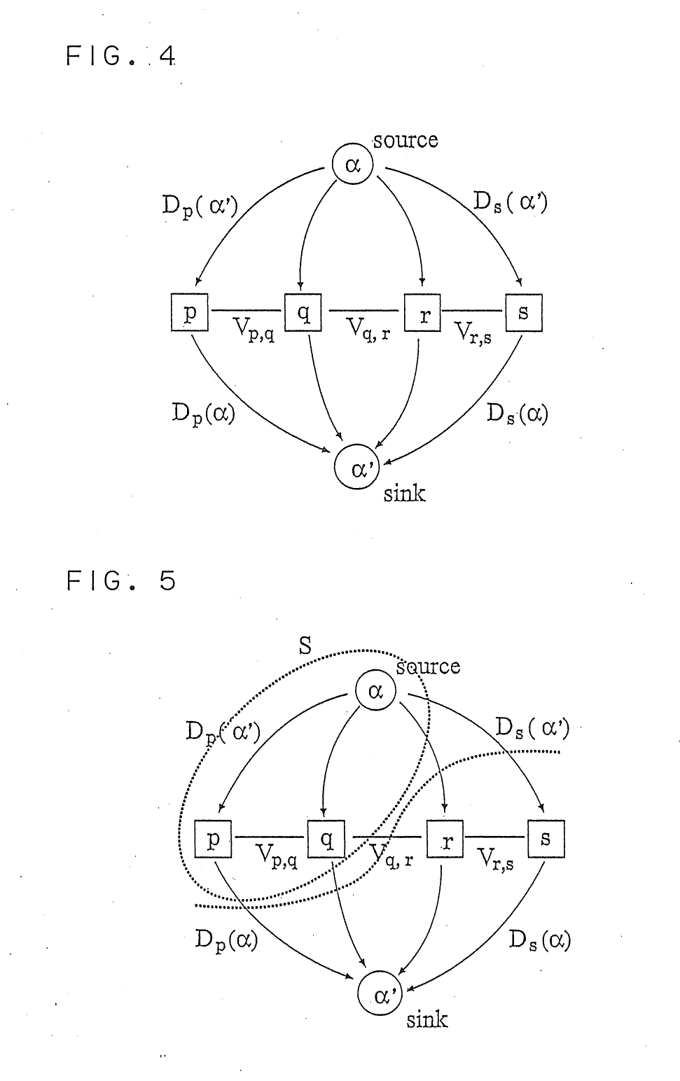

The data term calculating unit 20 and the smoothing term calculating unit 22 generate a graph G as shown in FIG. 4 from an intermediate result F_{cur} of the disparity affine parameter fα supplied by the disparity function setting unit 18 and the disparity affine parameter map.

Each of the round nodes at the top and bottom represents a disparity affine parameter. The upper node (source) represents the disparity affine parameter fα set by the disparity function setting unit 18, and the lower node (sink) represents the intermediate result F_{cur} of the disparity affine parameter map. Square nodes p, q, r and s correspond respectively to pixels. In other words, a graph generated when the pixel is composed of four pixels aligned laterally is exemplified.

These four nodes are each joined to the adjacent node, and are also joined to the upper and lower nodes (source and sink). These joint are referred to as “link,” and the each link is added with a weight calculated by the data term calculating unit 20 or by the smoothing term calculating unit 22.

The data term calculating unit 20 adds a weight to the link connecting the sink or the node and each point. The difference Dₚ(α′), D_{q}(α′), Dᵣ(α′) and Dₛ(α′) calculated by the initializing unit 16 are added to the links from the source (α) to the nodes p, q, r and s.

The difference given from the source to the link of the each node is, for example, in the case of the Dₚ(α′), the difference in disparity specified by the disparity function of the point p of the intermediate result F_{cur} of the disparity affine parameter map, and D_{q}(α′), Dᵣ(α′) and Dₛ(α′) are defined in the same manner.

The difference given to the link from the each node to the sink to be used is the difference of the disparity specified by the disparity affine parameter fα supplied by the disparity function setting unit 18.

The smoothing term calculating unit 22 adds a weight to the link connecting the adjacent nodes with respect to each other. For example, the weight V_{p,q}(fₚ, f_{q}) to be added to the link connecting the pixel (node) p and the pixel (node) q is given by the expression (10).

V_{p,q}(fₚ,f_{q})=λ·T(fₚ≠f_{q}), (10)

where fₚ and f_{q} denote the disparity affine parameter of the pixels (nodes) p and q, respectively, λ is a positive constant, T(·) is an operator which returns “1” when the condition provided as an argument is true, and returns “0” in other cases.

In other words, V_{p,q}(fₚ, f_{q}) becomes “0” when the disparity affine parameter of the pixels (nodes) p and q match, and becomes “λ” when they are different from each other. The value of λ may be the same value for all the pixels, and may be changed according to the luminance difference between the corresponding pixels.

The disparity function selecting unit 24 renews the disparity affine parameter by dividing the graph established by the data term calculating unit 20 and the smoothing term calculating unit 22 into two parts. The method of dividing will be descried below.

Firstly, it is assumed that one part includes the source and the other part includes the sink. The set of nodes including the source is denoted by S. The set of links outgoing from S and advancing toward the nodes other than S is referred to as cut, and the weight of the links included in the cut is referred to as cut capacity.

For example, in the case of division indicated by a dot line in FIG. 5, the elements of the set S are the source and the node p, q, and the cut is composed of five links in total which connects p and the sink, q and the sink, r and the source, s and the source, and r and s, respectively.

The cut having the minimum cut capacity from among the all available cuts is referred to as “minimum cut.” The disparity function selecting unit 24 divides the graph G by the minimum cut. The minimum cut is obtained, for example, by a graph cut algorism.

After having divided, the affine disparity function of the pixel (node) included it he partial set (S) including the source is renewed to fα, and the affine disparity function of the pixel (node) which is not included in S is not renewed.

The disparity affine parameter map F after having changed is supplied to the disparity function setting unit 18 as the intermediate result if the process for all the disparity functions set by the disparity function setting unit 18 is not terminated, and if it is terminated, F is outputted as the final result of the disparity data.

According to the preferred embodiment of the invention, high-density, high-accuracy disparity data may be obtained from a stereo image irrespective of the direction of inclination or presence or absence of a pattern of the surface of the object.

The invention is not limited to the embodiment shown above as is, and the components may be modified to embody without departing from the scope of the invention. Various modes of the invention are formed by the suitable combination of the plurality of components disclosed in the embodiment. For example, some components may be deleted from all the components shown in the embodiment. Furthermore, the components in the different embodiments may be combined as needed.

Other modification may be made without departing the scope of the invention.

In this embodiment, the stereo view in the case where the two cameras are arranged in lateral parallel has been described. However, the cameras may be arranged vertically, or three or more cameras may be used.

In this embodiment, the graph cut is used as the energy minimizing method. However, other optimizing algorism such as Belief Propagation may be employed.

In this embodiment, the case where the disparities of all pixels are globally estimated using the energy minimizing method has been described. However, the process maybe applied to a specific area.

For example, the disparity may be obtained by obtaining the disparity by the block matching, estimating the inclination of the surface of the object, and using the method described in this embodiment only for the area having the local inclination which is not parallel to the surface of the image.

In this embodiment, the disparity function is set as the linear function. However, the invention is not limited thereto, and quadratic function indicating a curved surface or other functions may be employed.

What is claimed is:

1. An image processing apparatus comprising:
an input unit configured to input a first image and a second image being input at different position and having a common field of view;
a disparity function storing unit configured to store disparity functions for obtaining disparities of a plurality of target points on the first image from coordinates of the individual target points;
a first calculating unit configured to calculate the disparity based on the disparity functions from the coordinates of the target points;
a second calculating unit configured to calculate corresponding points on the second image corresponding to the target points based on the calculated disparity;
a luminance difference calculating unit configured to calculate the luminance differences between the luminance of the target points and the luminance of the corresponding points respectively;
a consistency calculating unit configured to calculate the consistency the value of which is reduced with the increasing similarity between the disparity function of the each target point and the disparity function of another target point located around the each target point; and
a disparity function selecting unit configured to select a combination of the disparity functions with which the minimum sum of the luminance differences and the consistencies for the plurality of target points is obtained while changing the disparity functions of the target points respectively.

2. The apparatus according to claim 1, wherein the disparity function storing unit stores parameters of the disparity functions of the target points, and the disparity function selecting unit changes the disparity functions by changing the parameters.

3. The apparatus according to claim 2, wherein the disparity function is represented by d=αx+βy+γ, where (x, y) is a coordinate, d is the disparity, and α, β and γ are parameters.

4. The apparatus according to claim 1, wherein the luminance difference calculating unit calculates the difference between the luminance patterns of the peripheral area of the target points and the luminance patterns of the peripheral area of the corresponding points as the luminance difference.

5. The apparatus according to claim 1, further comprising a road area extracting unit configured to extract a road area on the first image based on the disparity function of each point on the first image and a preset function representing the road surface.

6. The apparatus according to claim 1, further comprising a disparity calculating unit configured to calculate the disparity of the each point on the reference image based on the disparity functions calculated by the disparity function selecting unit.

7. An image processing method, comprising steps of:
inputting a first image and a second image being input at different position and having a common field of view;
storing disparity functions for obtaining disparities of a plurality of target points on the first image from coordinates of the individual target points;
calculating the disparity based on the disparity functions from the coordinates of the target points;
calculating corresponding points on the second image corresponding to the target points based on the obtained disparity;
calculating the luminance differences between the luminance of the target points and the luminance of the corresponding points respectively;
calculating the consistency the value of which is reduced with the increasing similarity between the disparity function of the each target point and the disparity function of another target point located around the each target point; and
selecting a combination of the disparity functions with which the minimum sum of the luminance differences and the consistencies for the plurality of target points is obtained while changing the disparity functions of the target points respectively.

8. The method according to claim 7, wherein the storing step stores parameters of the disparity functions of the target points, and the disparity function selecting step selects the disparity functions by changing the parameters.

9. The method according to claim 8, wherein the disparity function is represented by d=αx+βy+γ, where (x, y) is a coordinate, d is the disparity, and α, β and γ are parameters.

10. The method according to claim 7, wherein the luminance difference calculating step calculates the difference between the luminance patterns of the peripheral area of the target points and the luminance patterns of the peripheral area of the corresponding points as the luminance difference.

11. The method according to claim 7, further comprising extracting a road area on the first image based on the disparity function of each point on the first image and a preset function representing the road surface.

12. The method according to claim 7, further comprising calculating the disparity of the each point on the reference image based on the disparity functions obtained by the disparity function selecting unit.
